(19) United States
(12) Patent Application Publication
(10) Pub. No.: US 2016/0329857 A1
(43) Pub. Date: Nov. 10, 2016

(54) SOLAR PANEL KIT

(71) Applicant: RSI Development LLC, Anaheim, CA (US)

(72) Inventor: JOHN DU, Hacienda Heights, CA (US)

(21) Appl. No.: 15/044,948

(22) Filed: Feb. 16, 2016

Related U.S. Application Data
(60) Provisional application No. 62/158,451, filed on May 7, 2015.

(51) Int. Cl. H02S 10/00; H02S 40/32; H02S 40/36; H02S 30/10

(52) U.S. Cl. CPC H02S 10/00; H02S 30/10; H02S 40/32; H02S 40/36

(57) ABSTRACT

A solar power generator kit can, for example, include a box and solar panels, micro-inverters, photovoltaic junction boxes, cables, mounting rails, and coupling components. The micro-inverters and photovoltaic junction boxes can be mounted to the solar panels. The cables can electrically connect the solar panels to the micro-inverters and the photovoltaic junction boxes. The mounting rails can mount the solar panels to a structure. The coupling components can operably connect the plurality of mounting rails. The box can store the solar panels, micro-inverters, photovoltaic junction boxes, cables, mounting rails, and coupling components.

### REFERENCE TO RELATED APPLICATIONS

The present application claims priority benefit under 35 U.S.C. §119 (e) from U.S. Provisional Patent Application No. 62/158,451, filed May 7, 2015, entitled “SOLAR PANEL KIT,” the disclosure of which is incorporated herein by reference.

### BACKGROUND

The present disclosure is generally related to solar panel technology.

### SUMMARY

In some embodiments, a solar power generator kit can include: a plurality of solar panels comprising solar cells; a plurality of micro-inverters mounted to the plurality of solar panels; a plurality of photovoltaic junction boxes mounted to the plurality of solar panels; a plurality of cables configured to electrically connect the plurality of solar panels to the plurality of micro-inverters and the plurality of photovoltaic junction boxes; a plurality of mounting rails configured to mount the plurality of solar panels to a structure; a plurality of coupling components configured to operably connect the plurality of mounting rails; and a box storing the plurality of solar panels, the plurality of micro-inverters, the plurality of photovoltaic junction boxes, the plurality of cables, the plurality of mounting rails, and the plurality of coupling components.

The solar panel generator kit of the preceding paragraph can include one or more of the following features: The solar cells can be positioned on first sides of the plurality of solar panels, and the plurality of micro-inverters and the plurality of photovoltaic junction boxes can be mounted on second sides of the plurality of solar panels opposite the first sides. The plurality of mounting rails and the plurality of coupling components can be electrically grounded such that the plurality of mounting rails, the plurality of coupling components, and the plurality of solar panels share a common electrical ground when the plurality of mounting rails and the plurality of coupling components are operably connected and the plurality of solar panels are mounted to the plurality of mounting rails. The plurality of coupling components can include a plurality of lugs, and when the plurality of mounting rails and the plurality of coupling components are operably connected and the plurality of solar panels are mounted to the plurality of mounting rails, the plurality of lugs can align and secure the plurality of solar panels and conduct electrical current so that the plurality of solar panels share the common electrical ground. At least one of the plurality of cables can include: a plurality of conductor lines configured to electrically connect a first micro-inverter of the plurality of micro-inverters to a second micro-inverter of the plurality of micro-inverters to transfer power from the first micro-inverter to the second micro-inverter; a female connector plug operably connected a first end of the plurality of conductor lines, the female connector plug configured to operably connect the plurality of conductor lines to the first micro-inverter; and a male connector plug operably connected a second end of the plurality of conductor lines opposite the first end, the male connector plug configured to operably connect the plurality of conductor lines to the second micro-inverter. Each of at least two of the plurality of cables can include: a plurality of conductor lines having a length greater than a width of a first solar panel of the plurality of solar panels, the plurality of conductor lines configured to electrically connect two of the plurality of micro-inverters; a female connector plug operably connected a first end of the plurality of conductor lines, the female connector plug configured to operably connect the plurality of conductor lines to one of the two of the plurality of micro-inverters; and a male connector plug operably connected a second end of the plurality of conductor lines opposite the first end, the male connected plug configured to operably connect the plurality of conductor lines to one of the two of the plurality of micro-inverters. One of the plurality of micro-inverters can be mounted to each of the plurality of solar panels, and one of the plurality of photovoltaic junction boxes can be mounted to each of the plurality of solar panels. A total number of solar panels of the plurality of solar panels can be two, and each of the plurality of solar panels can generate 250 W. A total number of solar panels of the plurality of solar panels can be four.

In some embodiments, a solar power generator device can include: a solar panel comprising solar cells on a first side of the solar panel, the solar cells configured to generate electricity from electromagnetic radiation incident on the solar cells; and a micro-inverter mounted on a second side of the solar panel opposite the first side.

The solar power generator device of the preceding paragraph can include one or more of the following features: The micro-inverter can be mounted to a frame along a perimeter of the solar panel. The frame can include a flange, and the micro-inverter can be mounted to the flange. The micro-inverter can be mounted with a fastener to the flange. The micro-inverter can be mounted within an open portion of the solar panel on the second side so that the micro-inverter does not project from the open portion beyond a plane extending level with an outer periphery surface of the flange. The micro-inverter can be mounted so that the micro-inverter does not project beyond a back outer periphery surface or an edge outer periphery surface of the solar panel. The solar power generator device can further include a photovoltaic junction box mounted to the solar panel within the open portion so that the photovoltaic junction box does not project beyond the top edge and the back edge.

In some embodiments, an assembly can include: a first solar panel comprising solar cells, the solar cells configured to generate electricity from electromagnetic radiation incident on the solar cells; and a first cable comprising: a plurality of conductor lines having a length greater than a width of the first solar panel, the plurality of conductor lines configured to electrically connect a first micro-inverter associated with the first solar panel to a second micro-inverter, a female connector plug operably connected a first end of the plurality of conductor lines, the female connector plug configured to operably connect to the first micro-inverter, and a male connector plug operably connected a second end of the plurality of conductor lines opposite the first end, the male connector plug configured to operably connect to the second micro-inverter.

The assembly of the preceding paragraph can include one or more of the following features: The assembly can be in combination with the first micro-inverter and the second micro-inverter, and further include a second solar panel, the second micro-inverter associated with the second solar panel, the plurality of conductor lines has a length greater than a combined width of the first solar panel and the second solar panel. The assembly can further include a second solar panel associated with the second micro-inverter, and the first solar panel and the second solar panel can be mounted on a structure and separated by a distance of at least the width of the first solar panel, the width of the first solar panel being 99.2 cm, and the first micro-inverter and the second micro-inverter can be electrically connected via the plurality of conductor lines. The first solar panel and the second solar panel can be separated by a distance of at least a combined width of the first solar panel and the second solar panel. The assembly can further include: a second solar panel associated with the second micro-inverter; and a second cable configured to operably connect the second micro-inverter to a third micro-inverter, the second cable having a length less than the width of the first solar panel. The female connector plug can be capable of operably connecting to the male connector plug.

### BRIEF DESCRIPTION OF THE DRAWINGS

FIG. 1A illustrates an example solar power generation system.

FIG. 1B illustrates an example electrical schematic for parts of the solar power generation system of FIG. 1A.

FIG. 2A illustrates a back view of an example solar panel module that can be included in the solar power generation system of FIG. 1A.

FIG. 2B illustrates a front view of the solar panel module of FIG. 2A.

FIG. 2C illustrates a magnified view of an example micro-inverter.

FIG. 2D illustrates the solar panel module of FIG. 2A with a cable secured by the solar panel module.

FIG. 2E illustrates a side view of the solar panel module of FIG. 2A.

FIG. 3A illustrates an example mounting kit for mounting a solar panel module.

FIG. 3B illustrates a magnified view of an example flashing cover of the mounting kit of FIG. 3A.

FIG. 3C illustrates a magnified view of an example hook of the mounting kit of FIG. 3A mounted to a roof of a structure.

FIG. 3D illustrates a magnified view of the hook of FIG. 3C with the flashing cover of FIG. 3B mounted over the hook.

FIG. 3E illustrates an example assembly configuration for part of the mounting kit of FIG. 3A.

FIG. 3F illustrates the assembly configuration of FIG. 3E and the solar panel module of FIG. 2B mounted to a roof of a structure.

FIG. 4 illustrates a front view of an example box for storing a solar panel kit that can include the solar panel module of FIG. 2A and the mounting kit of FIG. 3A.

FIG. 5 illustrates an example connector cable for electrically connecting two solar panel modules.

FIGS. 6A, 6B, and 6C illustrate example installation configurations for one or more solar panel kits, such as the solar panel kit of FIG. 4.

### DETAILED DESCRIPTION

### Introduction

The installation of a solar power generation system, such as a solar panel system on a residential roof, can be an expensive, time-consuming, and dangerous process. The installation may cost tens of thousands of dollars, take five days to complete, and involve working with electrical conductors that can severely injure an installer. Moreover, the installation can be a relatively complicated process providing room for errors or mistakes that can result in system failure and injury to someone near the system, among other possible issues.

Embodiments described herein can address one or more of the foregoing problems with solar power generation systems in certain instances. For example, the components of a solar power generation system can be provided in a preassembled kit including one or more solar panels, such as two or four solar panels. The components of the kit can be pre-tested for proper functionality before being provided to an installer of the components. In addition, the components of the kit can be pre-grounded before being provided the installer so that when the installer constructs the solar power generation system from the kit and once the components are fully installed, the risk of injury due to electrical discharge from the solar power generation system can be significantly reduced. One or more or all of the components of the kits can be designed with unique and appropriately matching interfaces so that the components may be installed in a proper orientation, direction, and coupling and not in an improper orientation, direction, and coupling, thereby further preventing mistakes in the construction of the solar power generation system. As a result, the components can be installed by a handyman (sometimes referred to a handyperson) rather than an electrician or a solar specialist because the components may utilize less expertise to install than that of an electrician or a solar specialist. The components can be used to construct the solar power generation system in a matter of hours, such as 5 hours, rather than days, such as 5 days. The kits can be used to construct solar power generation systems for residential, commercial, or other uses.

Multiple kits can be electrically connected to each other to construct a solar power generation system that generates additional power. For example, four kits may be electrically connected to one another. The multiple kits can further be balanced with one another such that each of the multiple kits may have the same or similar properties or components enabling the same or similar power generation capabilities for each kit. As a result, the power output potential for the individual kits of the multiple kits and the solar power generation system can be maximized.

### Solar Power Generation System

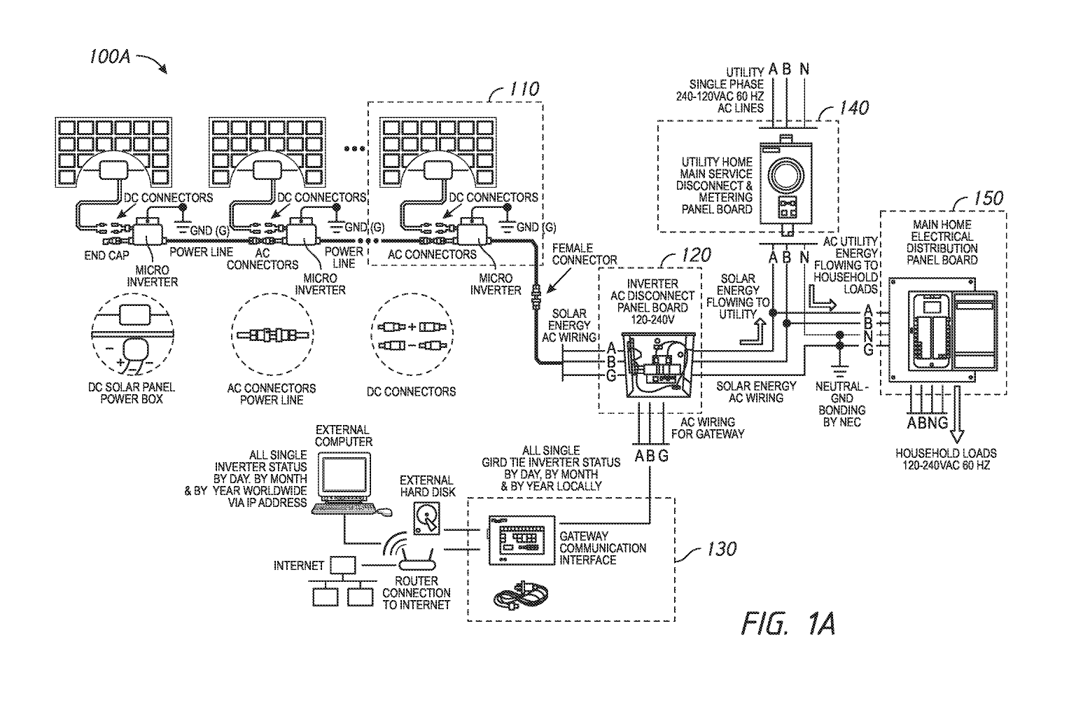

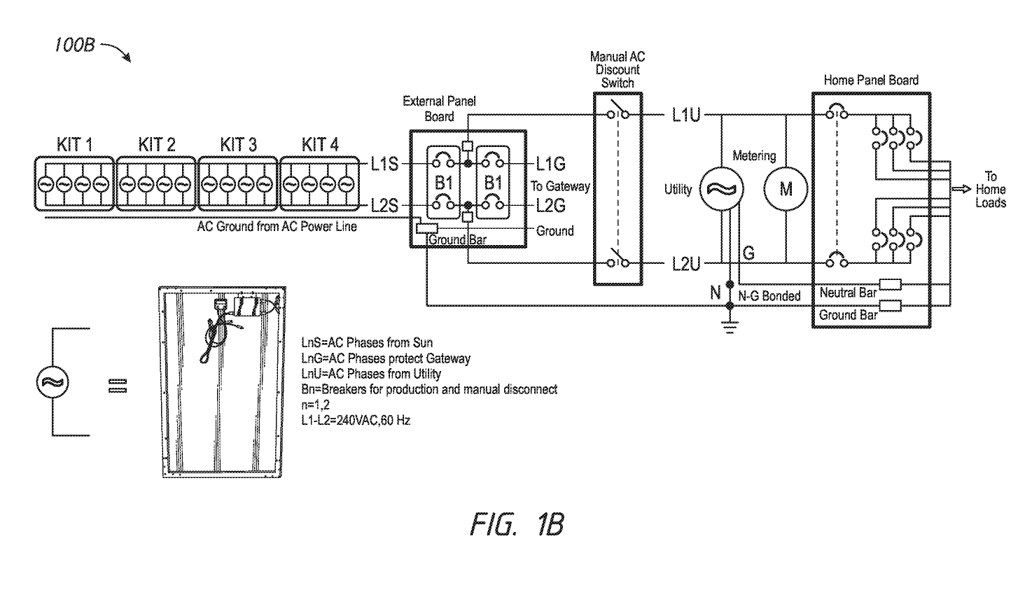

FIG. 1A illustrates an example solar power generation system 100A. The solar power generation system 100A can include multiple solar panel modules including a solar panel module 110. The solar panel module 110 can be constructed from components of a solar panel kit as described herein.

The solar power generation system 100A can further include an inverter AC disconnect panel board 120, a gateway communication interface 130, a disconnect and metering panel board 140, and an electrical distribution board 150. The multiple solar panel modules, such as the solar panel module 110, can generate and provide electrical power to the inverter AC disconnect panel board 120. The gateway communication interface 130 can monitor electricity traveling through the inverter AC disconnect panel board 120 and report to a user about an amount of electricity generated by the multiple solar panel modules. The inverter AC disconnect panel board 120 can further provide electrical power to the disconnect and metering panel board 140 and the electrical distribution board 150.

FIG. 1B illustrates an example electrical schematic for a solar power generation system 1008. The solar power generation system 100B, as shown, can include sixteen solar panel modules and, as will be appreciated by one of skill in the art, may include components of the solar power generation system 100A.

### Solar Panel Kit

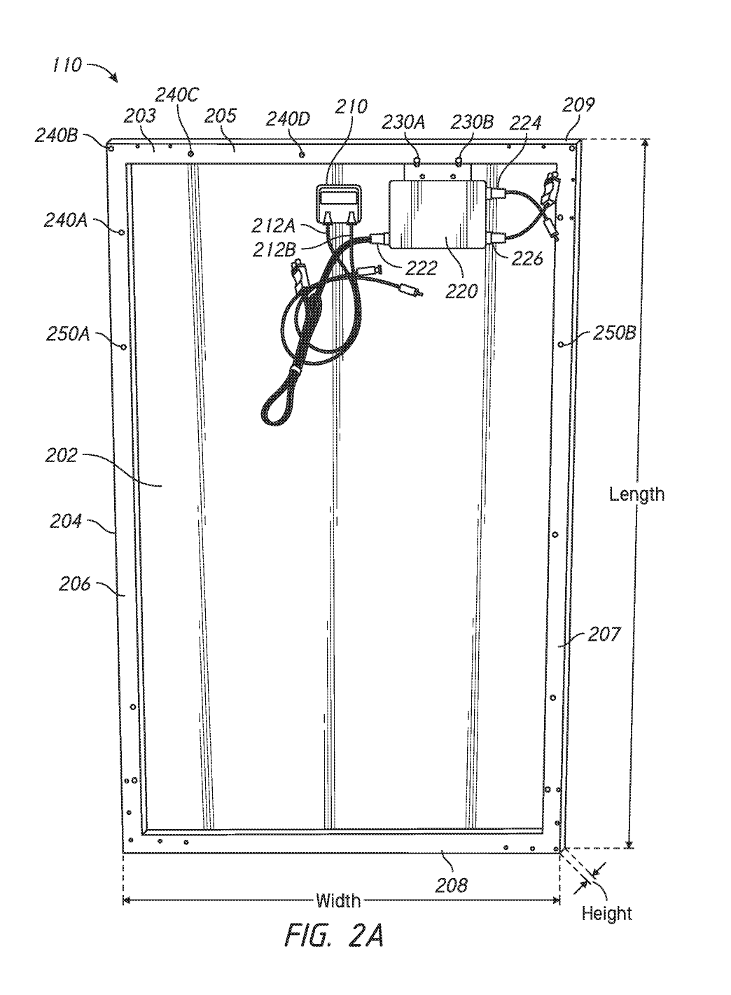

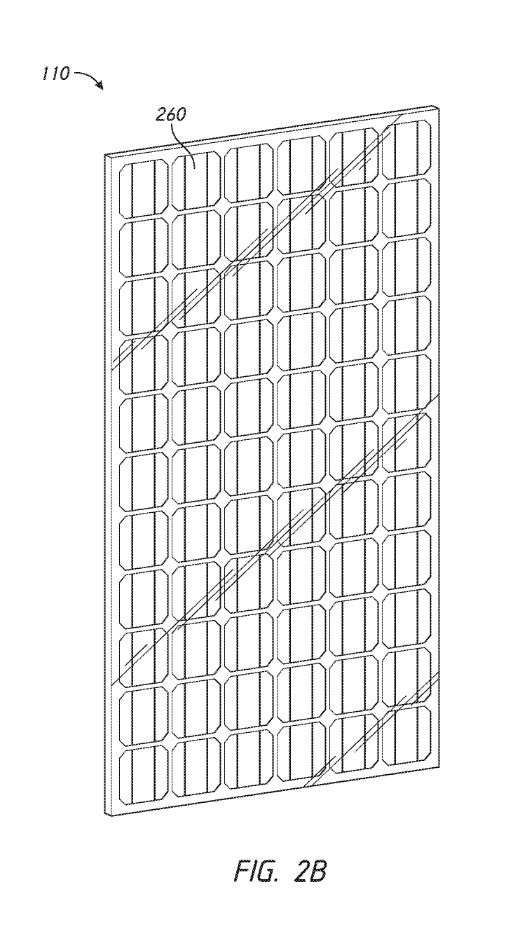

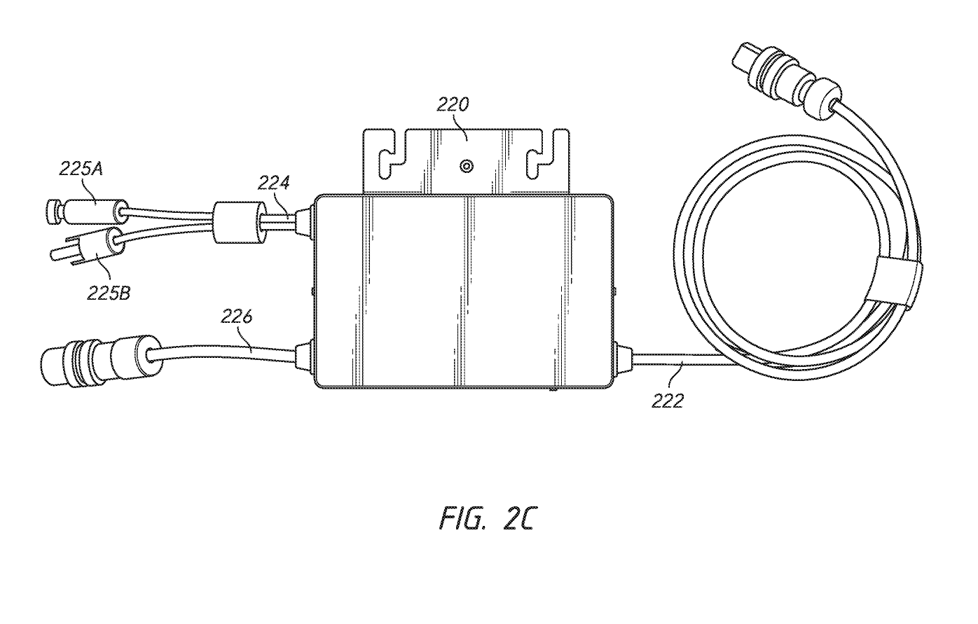

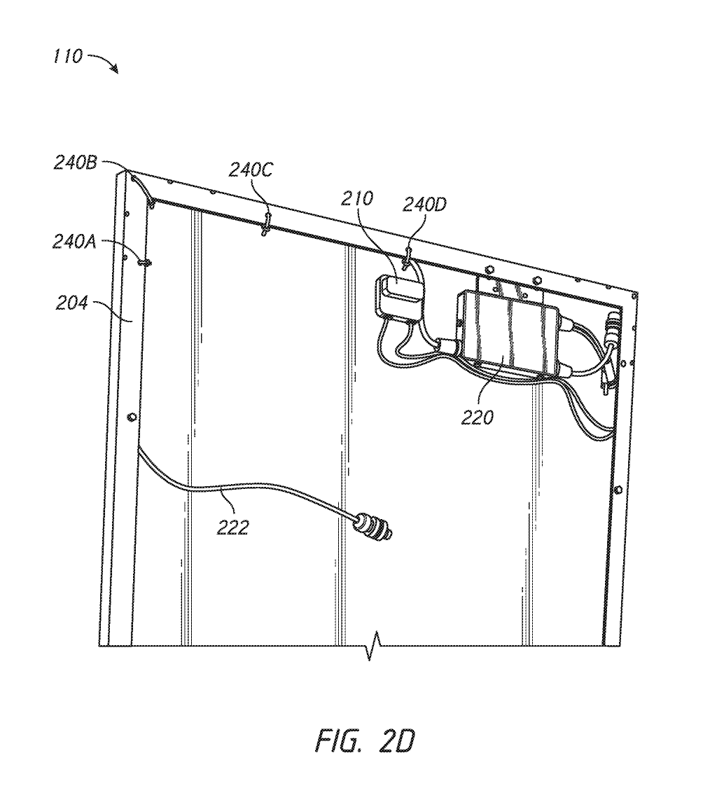

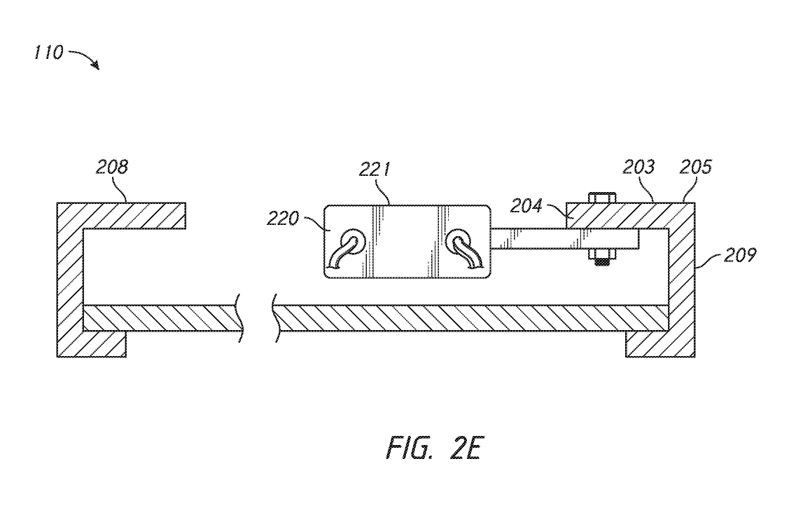

FIG. 2A illustrates a back view of the solar panel module 110 according to some embodiments. The solar panel module 110 can include a solar panel 202, a photovoltaic junction box 210, and a micro-inverter 220.

The solar panel module 110 can include a frame 204 around a perimeter of the solar panel 202. The frame 204 can include a flange or overhang on one or more sides of the solar panel module 110 (for instance, all four sides as shown) that can extends inwards and creates a lip along a back outer periphery surface 203 of the solar panel module 110, as well as that defines an open portion on a back of the solar panel module 110. The back outer periphery surface 203 can be a rear most surface of the frame 204.

The flange of the frame 204 can include a top flange 205 that includes holes 230A, 230B, 240B, 240C, 240D, side flanges 206, 207 that include holes 240A, 240B, 250A, 250B, and a bottom flange 208. The solar panel module 110 can have an edge outer periphery surface 209 formed by the frame 204. The edge outer periphery surface 209 can be an outer most side edge surface of the frame 204 along a top, sides, and bottom of the frame 204 and can include a top edge outer periphery surface, side edge outer periphery surfaces, and a bottom outer periphery surface.

Although the solar panel 202 and the frame 204 may be separately described or defined in the discussion of FIG. 2A, the combination of the solar panel 202 and the frame 204 can be together referred to as a solar panel in some instances.

In one implementation, the solar panel module 110 can have dimensions of 165 cm (length)×99.2 cm (width)×4 cm (height). In some implementations, the solar panel module 110 can have (i) a length of at least 10 cm, 25 cm, 50 cm, 75 cm, 100 cm, 125 cm, 150 cm, 175 cm, 200 cm, 225 cm, 250 cm, 275 cm, 300 cm, 350 cm, 400 cm, 450 cm, 500 cm, 600 cm, 750 cm, 850 cm, 1000 cm, or 5000 cm, (ii) a width of at least 10 cm, 25 cm, 50 cm, 75 cm, 100 cm, 125 cm, 150 cm, 175 cm, 200 cm, 225 cm, 250 cm, 300 cm, 350 cm, 400 cm, 450 cm, 500 cm, 600 cm, 750 cm, 850 cm, 1000 cm, or 5000 cm, and (iii) a height of at least 0.5 cm, 1 cm, 1.5 cm, 2 cm, 2.5 cm, 3 cm, 3.5 cm, 4 cm, 4.5 cm, 5 cm, 5.5 cm, 6 cm, 6.5 cm, 7 cm, 7.5 cm, 8 cm, 9 cm, 10 cm, 12 cm, 15 cm, 20 cm, 25 cm, 30 cm, 40 cm, or 50 cm. In some implementations, the solar panel module 110 can have (i) a length of no more than 10 cm, 25 cm, 50 cm, 75 cm, 100 cm, 125 cm, 150 cm, 175 cm, 200 cm, 225 cm, 250 cm, 275 cm, 300 cm, 350 cm, 400 cm, 450 cm, 500 cm, 600 cm, 750 cm, 850 cm, 1000 cm, or 5000 cm, (ii) a width of no more than 10 cm, 25 cm, 50 cm, 75 cm, 100 cm, 125 cm, 150 cm, 175 cm, 200 cm, 225 cm, 250 cm, 300 cm, 350 cm, 400 cm, 450 cm, 500 cm, 600 cm, 750 cm, 850 cm, 1000 cm, or 5000 cm, and (iii) a height of no more than 0.5 cm, 1 cm, 1.5 cm, 2 cm, 2.5 cm, 3 cm, 3.5 cm, 4 cm, 4.5 cm, 5 cm, 5.5 cm, 6 cm, 6.5 cm, 7 cm, 7.5 cm, 8 cm, 9 cm, 10 cm, 12 cm, 15 cm, 20 cm, 25 cm, 30 cm, 40 cm, or 50 cm. In some implementations, the solar panel module 110 can have (i) a length ranging from 10 cm to 5000 cm, 25 cm to 1000 cm, 50 cm to 500 cm, 75 cm to 250 cm, 125 cm to 200 cm, or 150 cm to 175 cm, (ii) a width ranging from 10 cm to 1000 cm, 25 cm to 500 cm, 50 cm to 250 cm, 75 cm to 150 cm, 85 cm to 115 cm, or 95 cm to 105 cm, and (iii) a height ranging from 0.5 cm to 50 cm, 1 cm to 25 cm, 1.5 cm to 15 cm, 2 cm to 10 cm, 2.5 cm to 7.5 cm, or 3 cm to 5 cm.

In one implementation, the solar panel module 110 can have a surface area (length x width) of at least 100 cm², 1000 cm², 5000 cm², 10 m², 50 m², 100 m², 500 m², 1000 m², or 25 km². In some implementations, the solar panel module 110 can have a surface area (length×width) of no more than 100 cm², 1000 cm², 5000 cm², 10 m², 50 m², 100 m², 500 m², 1000 m², or 25 km². In some implementations, the solar panel module 110 can have a surface area (length×width) ranging from between 100 cm² to 25 km², 1000 cm² to 1000 m², 5000 cm² to 500 m², 10 m² to 100 m², or 25 m² to 75 m².

The photovoltaic junction box 210 can be mounted to a back surface of the solar panel 202 near a top edge as shown or at other positions along the back surface or side of the solar panel 202 or solar panel module 110, such as along another edge or near the center of a back of the solar panel 202 or on the top flange 205, side flanges 206, 207, or bottom flange 208. The photovoltaic junction box 210 can be electrically connected to the solar panel 202 and cables 212A, 212B. The cables 212A, 212B can output electrical power generated by the solar panel module 110 from electromagnetic radiation incident on the solar panel 202. The cables 212A, 2128 can be electrically connected to the micro-inverter 220 via a cable 224.

FIG. 2C illustrates a magnified view of the micro-inverter 220 and a view from the opposite side of the micro-inverter 220 shown in FIG. 2A. As can be seen from FIG. 2C, the cable 224 can be a Y cable that forks into cables 225A, 225B that can be electrically connected to the cables 212A, 212B to pass a direct current (DC) voltage from the photovoltaic junction box 210 to the micro-inverter 220.

The micro-inverter 220 can convert the DC voltage from the photovoltaic junction box 210 to an alternating current (AC) voltage. The micro-inverter 220 can be mounted to the frame 204 of the solar panel module 110 (for instance, to the flange of the frame 204, like the top flange 205, side flanges 206, 207, or bottom flange 208) or at other position on the back or side of the solar panel module 110. The micro-inverter 220 can be secured, for instance, using one or more fasteners, such as screws or locking mechanisms connected to the holes 230A, 230B, such as via the mounting grooves shown in FIG. 2C. In some implementations, at least part of the one or more fasteners used to secure the micro-inverter 220 can project beyond a plane extending level with the back outer periphery surface 203.

FIG. 2E illustrates a side view of the solar panel module 110 showing the micro-inverter 220 mounted to the frame 204. As can be seen from FIG. 2E, as well as FIG. 2D, the micro-inverter 220 can, in some embodiments, be mounted within the open portion of the solar panel module 110 so that at least part of the micro-inverter 220 (such as an inverter outer periphery surface 221 of the micro-inverter 220) may not project beyond the back outer periphery surface 203 or the edge outer periphery surface 209 of the solar panel module 110, so as to facilitate easier positioning or stacking of the solar panel module 110 for transportation. The inverter outer periphery surface 221 can, for instance, be below or flush with a plane extending level with the back outer periphery surface 203. Moreover, the micro-inverter 220 can, for example, be behind or flush with a plane extending level with the edge outer periphery surface 209, such as the top edge outer periphery surface, the side edge outer periphery surfaces, and the bottom outer periphery surface.

In some implementations, at least part of the micro-inverter 220 can project beyond a plane extending level with the back outer periphery surface 203, such as by no more than 0.5 cm, 1 cm, 1.5 cm, 2 cm, 2.5 cm, 3 cm, 5 cm, 6 cm, 7 cm, 8 cm, 9 cm, or 10 cm, and may project in such a way to facilitate easier but uneven stacking of the solar panel module 110 or alternative box designed for storing the solar panel module 110. In some implementations, at least part of the micro-inverter 220 can project beyond one or more planes extending level with the edge outer periphery surface 209 (including a plane extending level with the top edge outer periphery surface, a plane extending level with a left side edge periphery surface, a plane extending level with a right side edge periphery surface, and a plane extending level with the bottom outer periphery surface), such as by no more than 0.5 cm, 1 cm, 1.5 cm, 2 cm, 2.5 cm, 3 cm, 5 cm, 6 cm, 7 cm, 8 cm, 9 cm, or 10 cm, and may project in such a way to facilitate easier but uneven stacking of the solar panel module 110 or alternative box designed for storing the solar panel module 110.

Mounting of the micro-inverter 220 to the solar panel module 110 can be a counter-intuitive because such mounting can involve altering (for example, drilling) of the frame 204 and risking potentially damaging the solar panel 202 while altering the solar panel module 110.

The micro-inverter 220 can be electrically connected to a cable 222 that can electrically connect to another solar panel module to transfer electrical power via an AC voltage or the inverter AC disconnect panel board 120 of FIG. 1A. The micro-inverter 220 can be electrically connected to a cable 226 that can electrically connect to another solar panel module to transfer electrical power via an AC voltage or remain electrically open. In one example, a male plug of the cable 222 can operably connect to a female plug of a cable of another solar panel module that is like a female plug of the cable 226 to transfer electrical power, and a female plug of the cable 226 can operably connect to a male plug of a cable of another solar panel module that is like a male plug of the cable 222 to transfer electrical power.

The frame 204 can include the holes 240A-D at least for securing a cable, such as the cable 222, along an underside of the flange of the frame 204 using one or more fasteners, such as brackets or ties. One example embodiment for securing the cable 222 is depicted in FIG. 2D. Advantageously, in certain embodiments, by securing a cable using the holes 240A-D, the cable can be prevented from moving around and experiencing additional wear, such as by moving in the wind and beating on a roof.

The frame 204 can include the holes 250A, 250B in the flange of the frame 204 for inserting projections, such as bolts or brackets, used stabilize the solar panel module 110 and prevent sliding down of the solar panel module 110 when the solar panel module 110 is being installed. The projections can hang along an edge of a positioning mount including mounting rails and hold the solar panel module 100. The projections thus can be advantageously used, in certain embodiments, to at least temporarily catch and hold the solar panel module 110 in place during installation of the solar panel module 110 before the solar panel module 110 is secured to positioning mount using a more secure or permanent securing mechanism.

FIG. 2B illustrates a front view of the solar panel module 110 according to some embodiments. The solar panel module 110 can include solar cells 260 of the solar panel 202 used to generate electrical power from electromagnetic radiation incident on the solar cells 260. An outer surface of the solar cells 260 or an outer surface of the frame 204 extending around a front of the solar panel module 110 can form a front outer periphery surface of the solar panel module 110 and extend parallel to a direction extended by the back outer periphery surface 203. The front outer periphery surface and the back outer periphery surface 203 can be connected by the edge outer periphery surface 209.

In some implementations, the solar panel module 110 can use the solar cells 260 to generate 250 W. In some implementations, the solar panel module 110 can generate at least 10 W, 25 W, 50 W, 75 W, 100 W, 150 W, 200 W, 250 W, 300 W, 350 W, 400 W, 500 W, 600 W, 750 W, 1000 W, 1250 W, 1500 W, 2500 W, or 5000 W. In some implementations, the solar panel module 110 can generate no more than 10 W, 25 W, 50 W, 75 W, 100 W, 150 W, 200 W, 250 W, 300 W, 350 W, 400 W, 500 W, 600 W, 750 W, 1000 W, 1250 W, 1500 W, 2500 W, or 5000 W. In some implementations, the solar panel module 110 can generate 10 W to 5000 W, 25 W to 2500 W, 50 W to 1250 W, 100 W to 750 W, 150 W to 350 W, or 200 W to 300 W.

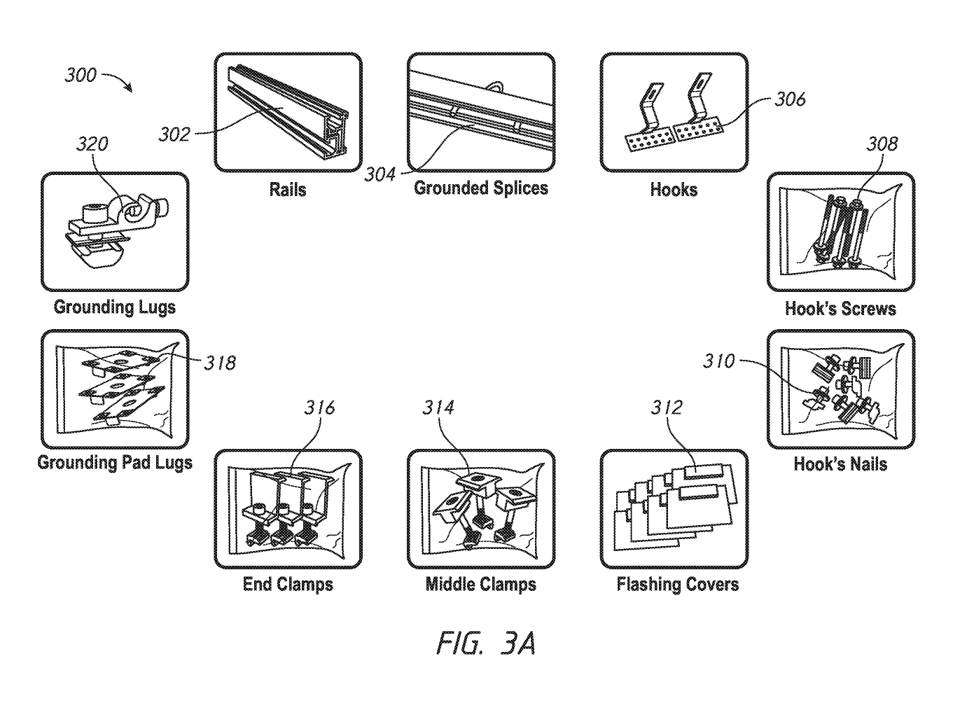

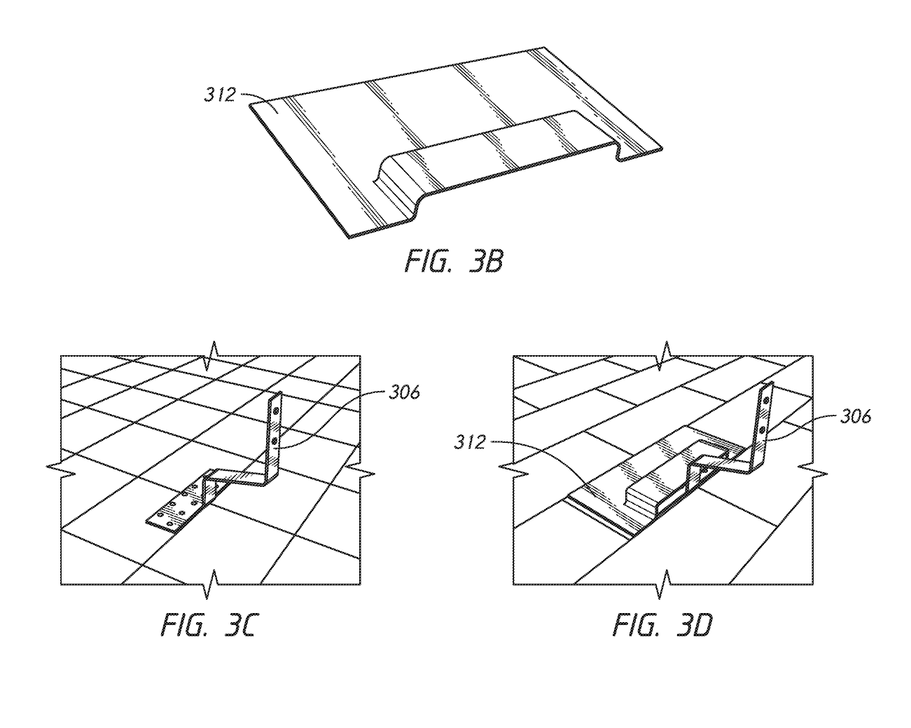

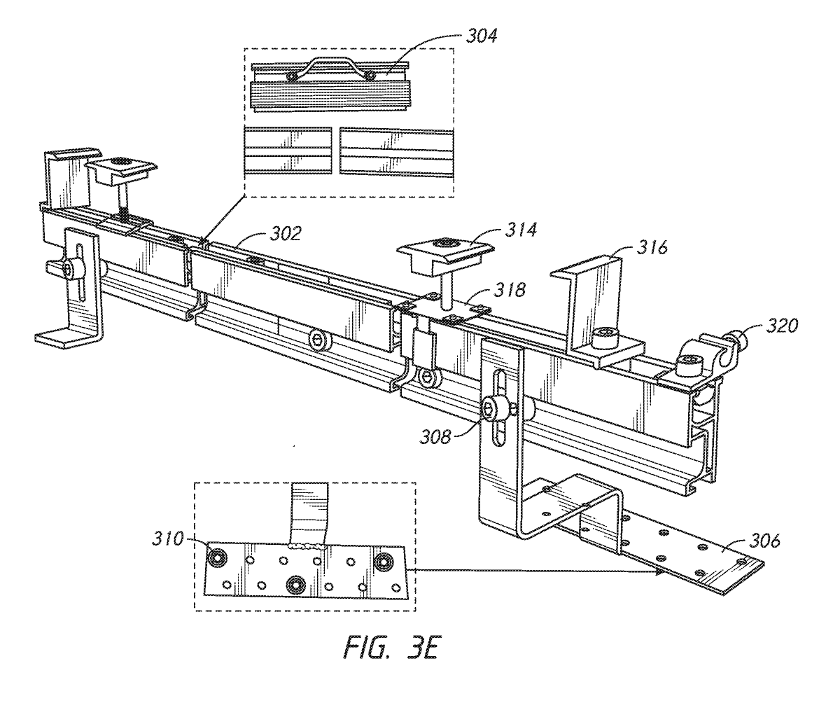

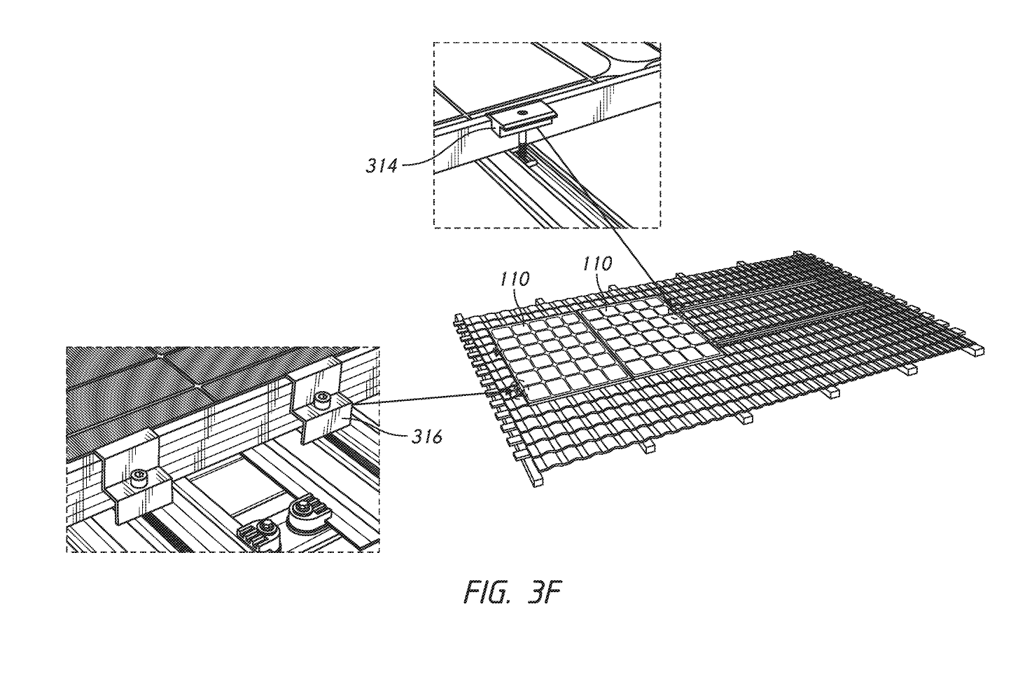

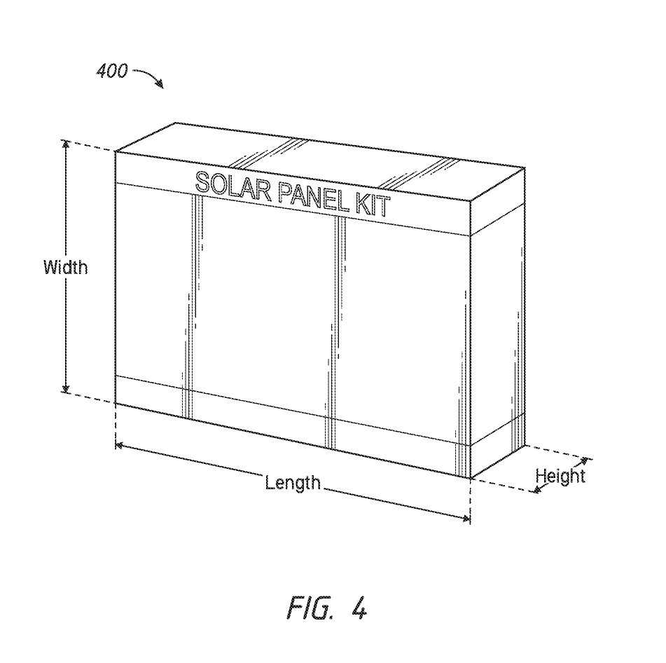

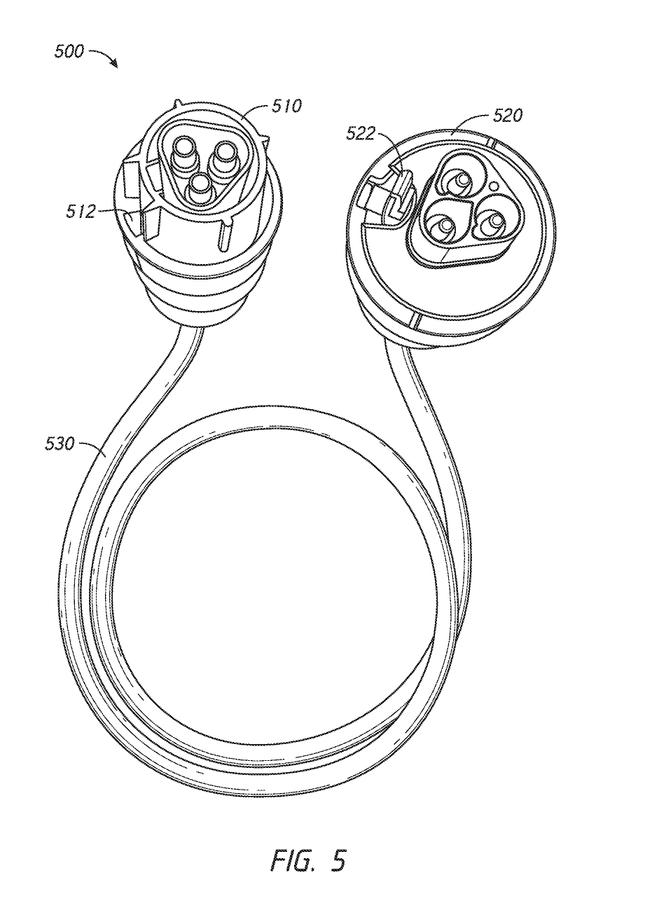

FIG. 3A illustrates a mounting kit 300 for mounting one or more solar panel modules to a surface. The mounting kit 300 can be used, for instance, for mounting four solar panel modules, including the solar panel module 110, to a residential or commercial building roof. The mounting kit 300 can include rails 302, grounded splices 304, hooks 306, hook's screws 308, hook's nails 310, flashing covers 312, middle clamps 314, end clamps 316, grounding pad lugs 318, and grounding lugs 320. In one implementation usable, for instance to mount four solar panel modules, the mounting kit 300 can include eight sets of the rails 302, six sets of the grounded splices 304, eight sets of the hooks 306, twenty-four sets of the hook's screws 308, eight sets of the hook's nails 310, eight sets of the flashing covers 312, six sets of the middle clamps 314, four sets of the end clamps 316, five sets of the grounding pad lugs 318, and two sets of the grounding lugs 320. In other implementations, a greater or fewer number of sets of the rails 302, the grounded splices 304, the hooks 306, the hook's screws 308, the hook's nails 310, the flashing covers 312, the middle clamps 314, the end clamps 316, the grounding pad lugs 318, and the grounding lugs 320 can be included in the mounting kit 300, and the number of sets can depend at least on a number of solar panel modules provided with the mounting kit 300. Notably, one or more representative components of each of the components that may be included in the mounting kit 300 are depicted in FIG. 3A.

Moreover, as will be appreciated by one of skill in the art, some of the components of the mounting kit 300 may not be included in the mounting kit 300 or other components not depicted in FIG. 3A (for example, a gateway interface, an electrical box, a quick disconnect, roofing paper, and additional securing mechanisms like fasteners for additionally securing the solar panel module 110 to one or more of the rails 302) can be included in the mounting kit 300 and yet at least some of the benefits of this disclosure may nonetheless be enjoyed for such an implementation.

One of the flashing covers 312 can be used for securing the solar panel module 110 to the surface. A magnified view of one of the flashing covers 312 is shown in FIG. 3B. The flashing covers 312 can, in certain embodiments, advantageously be bent plates that can provide additional strength to a mounting of the solar panel module 110. The bent plate structure of the flashing covers 312 can further enable the flashing covers 312 to be more visible during installation and thereby prevent the flashing covers 312 from being stepped on during installation, which can result in damage to or breaking of the seal at the location which the mounting for the solar panel module 110 may penetrate the surface and be secured to the surface.

As illustrated in FIG. 3C, one of the hooks 306 can be mounted to the surface. As illustrated in FIG. 3D, one of the flashing covers 312 can then be mounted over one of the hooks 306, such as using an adhesive or fasteners, and together can form at least part of the base for mounting the solar panel module 110 to the surface.

FIG. 3E illustrates an assembly configuration for at least some parts of the mounting kit 300. As can be seen from FIG. 3E, two of the rails 302 can be operably connected and electrically grounded using one of the grounded splices 304. At least two of the middle clamps 314 and at least two of the end clamps 316 can be positioned on the rails 302 and used to align and secure a solar panel module, such as the solar panel module 110, to the assembly configuration. One of the grounding pad lugs 318 can be positioned between each of the middle clamps 314 and the rails 302 and can electrically ground the middle clamps 314 to the rails 302. The rails 302 can operably and electrically connect to the hooks 306 using the hook's screws 310. The hooks 306, in turn, can be operably connected to the surface using the hook's nails 310. The grounding lugs 320 can be operably and electrically connected to the rails 302, such as on ends of the rails 302, and provide coupling points where electrical ground for the rails 302 can be electrically connected to Earth or another ground, as well as potential to a ground of another solar panel, to safely dissipate electrical energy. Accordingly, once the assembly configuration of FIG. 3E may be fully constructed, the solar panel module 110, the rails 302, the grounded splices 304, the middle clamps 314, the end clamps 316, the grounding pad lugs 318, and the grounding lugs 320 can share a common electrical ground. This shared ground can advantageously, in certain embodiments, provide greater safety to installers of a solar panel generation system using the solar panel module 110 and the mounting kit 300.

FIG. 3F illustrates how the assembly configuration of FIG. 3E can be used to mount two solar panel modules, such as two fabrications of the solar panel module 110. In particular, FIG. 3F shows at least one of the middle clamps 314 and at least one of the end clamps 316 being used to secure the two fabrications of the solar panel module 100.

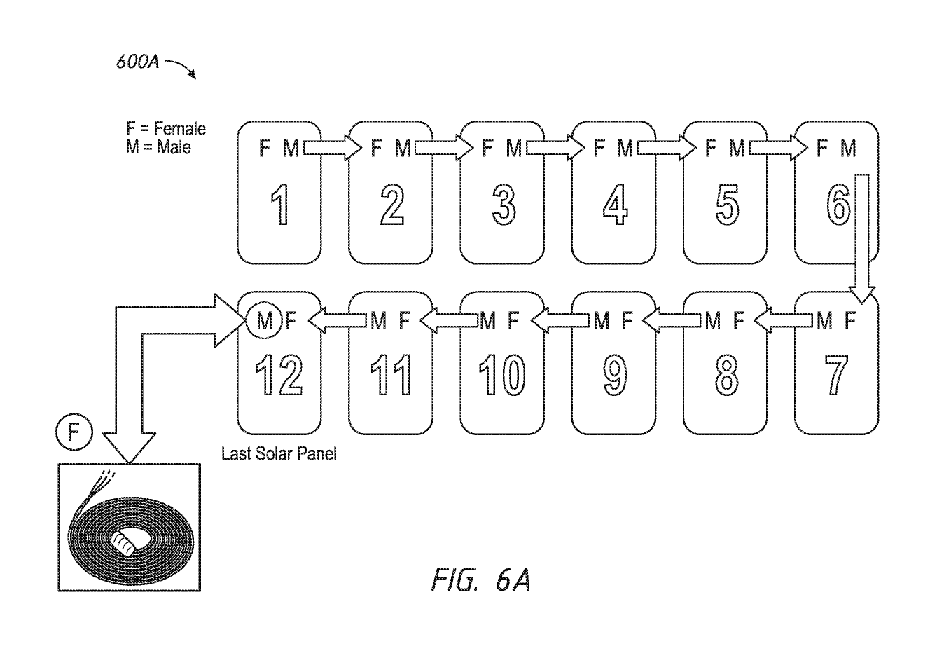

FIG. 4 illustrates a front view of a box 400 for storing components of a solar panel kit. For example, the box 400 can store the mounting kit 300 and four fabrications of the solar panel module 110 within the box 400. The box 400 can, for instance, be composed of one or more of cardboard, plastic, wood, or metal.

In one implementation, the box 400 can have dimensions of 170 cm (length)×105 cm (width)×30 cm (height). In some implementations, the box 400 can have (i) a length of at least 10 cm, 25 cm, 50 cm, 75 cm, 100 cm, 125 cm, 150 cm, 175 cm, 200 cm, 225 cm, 250 cm, 275 cm, 300 cm, 350 cm, 400 cm, 450 cm, 500 cm, 600 cm, 750 cm, 850 cm, 1000 cm, or 5000 cm, (ii) a width of at least 10 cm, 25 cm, 50 cm, 75 cm, 100 cm, 125 cm, 150 cm, 175 cm. 200 cm, 225 cm, 250 cm, 300 cm, 350 cm, 400 cm, 450 cm, 500 cm, 600 cm, 750 cm, 850 cm, 1000 cm, or 5000 cm, and (iii) a height of at least 0.5 cm, 1 cm, 1.5 cm, 2 cm, 2.5 cm, 3 cm, 3.5 cm, 4 cm, 4.5 cm, 5 cm, 5.5 cm, 6 cm, 6.5 cm, 7 cm, 7.5 cm, 8 cm, 9 cm, 10 cm, 12 cm, 15 cm, 20 cm, 25 cm, 30 cm, 40 cm, 50 cm, 75 cm, 100 cm, 150 cm, 200 cm, 250 cm, 300 cm, 400 cm, or 500 cm. In some implementations, the box 400 can have (i) a length of no more than 10 cm, 25 cm, 50 cm, 75 cm, 100 cm, 125 cm, 150 cm, 175 cm, 200 cm, 225 cm, 250 cm, 275 cm, 300 cm, 350 cm, 400 cm, 450 cm, 500 cm, 600 cm, 750 cm, 850 cm, 1000 cm, or 5000 cm, (ii) a width of no more than 10 cm, 25 cm, 50 cm, 75 cm, 100 cm, 125 cm, 150 cm, 175 cm. 200 cm, 225 cm, 250 cm, 300 cm, 350 cm, 400 cm, 450 cm, 500 cm, 600 cm, 750 cm, 850 cm, 1000 cm, or 5000 cm, and (iii) a height of no more than 0.5 cm, 1 cm, 1.5 cm, 2 cm, 2.5 cm, 3 cm, 3.5 cm, 4 cm, 4.5 cm, 5 cm, 5.5 cm, 6 cm, 6.5 cm, 7 cm, 7.5 cm, 8 cm, 9 cm, 10 cm, 12 cm, 15 cm, 20 cm, 25 cm, 30 cm, 40 cm, 50 cm, 75 cm, 100 cm, 150 cm, 200 cm, 250 cm, 300 cm, 400 cm, or 500 cm. In some implementations, the box 400 can have (i) a length ranging between 10 cm to 5000 cm, 25 cm to 1000 cm, 50 cm to 500 cm, 75 cm to 300 cm, 100 cm to 250 cm, 125 cm to 200 cm, or 160 cm to 190 cm, (ii) a width ranging between 10 cm to 5000 cm, 25 cm to 1000 cm, 35 cm to 500 cm, 50 cm to 300 cm, 75 cm to 250 cm, 85 cm to 150 cm, or 95 cm to 115 cm, and (iii) a height ranging from between 0.5 cm to 500 cm, 2 cm to 200 cm, 10 cm to 100 cm, 15 cm to 75 cm, 20 cm to 50 cm, or 25 cm to 35 cm.

When the box 400 may have the mounting kit 300 and four fabrications of the solar panel module 110 within the box 400, the box 400 can weigh, in one implementation, 75 kg. In some implementations, when the box 400 may have the mounting kit 300 and four fabrications of the solar panel module 110 within the box 400, the box 400 can weigh at least 5 kg, 10 kg, 20 kg, 30 kg, 40 kg, 50 kg, 60 kg, 70 kg, 75 kg, 80 kg, 90 kg, 100 kg, 120 kg, 140 kg, 175 kg, 200 kg, 300 kg, or 500 kg. In some implementations, when the box 400 may have the mounting kit 300 and four fabrications of the solar panel module 110 within the box 400, the box 400 can weigh no more than 5 kg, 10 kg, 20 kg, 30 kg, 40 kg, 50 kg, 60 kg, 70 kg, 75 kg, 80 kg, 90 kg, 100 kg, 120 kg, 140 kg, 175 kg, 200 kg, 300 kg, or 500 kg. In some implementations, when the box 400 may have the mounting kit 300 and four fabrications of the solar panel module 110 within the box 400, the box 400 can weigh between 5 kg to 500 kg, 10 kg to 200 kg, 30 kg to 150 kg, 50 kg to 120 kg, 60 kg to 90 kg, or 70 kg to 80 kg. In some instances, the box 400 can weigh more or less, such as depending at least on a number of solar panel modules provided with the mounting kit 300.

In some implementations, the box 400 can include some but not all of the components of the mounting kit 300 or one or more fabrications of the solar panel module 100. In some implementations, the box 400 can have one or more open sides (not shown) or one or more openable sides (not shown), such as one or more doors connected to the box 400 via a hinge and openable by pulling on a portion of the door opposite the hinge. In some implementations, the box 400 can include one or more dividers (not shown) (for example, horizontal, vertical, or angled dividers) within the box 400 to separate the parts stored in the box 400 into two or more different areas (for example, eight different areas having two or more different volumes) where one or more components of the mounting kit 300 or one or more fabrications of the solar panel module 110 can be separately stored from one or more other components of the mounting kit 300 or one or more other fabrications of the solar panel module 110. In some implementations, the box 400 can separate into two or more different pieces (not shown) where one or more components of the mounting kit 300 or one or more fabrications of the solar panel module 110 can be separately stored from one or more other components of the mounting kit 300 or one or more other fabrications of the solar panel module 110. When the box 400 may include the one or more dividers or the two or more different pieces, the box 400, parts within the box 400, or different areas within the box 400 can be labeled (for instance, with different identifying numbers or titles) to assist an individual that installs the parts with understanding how to assemble or install the mounting kit 300 or one or more fabrications of the solar panel module 110.

In some implementations, two or more components of the mounting kit 300 can be connected to form a subassembly before the two or more components are included in the box 400. As some examples, (i) the two of the rails 302 can be operably connected and electrically grounded via one of the grounded splices 304 to form one subassembly, (ii) one or more of the middle clamps 314 or one or more of the end clamps 316 can be operably connected and electrically grounded to one or more of the rails 302 to form one subassembly, (iii) one or more of the grounding pad lugs 318 can be positioned between the middle clamps 314 and the rails 302 to form one subassembly, and (iv) one or more of the grounding lugs 320 can be operably and electrically connected to the rails 302 to form one subassembly. Moreover, two or more of the subassemblies, such as the example subassemblies described in the preceding sentence, can be operably connected to form one or more combined subassemblies. As a result, the work performed by an individual that installs one or more fabrications of the solar panel module 110 to a surface using the mounting kit 300 can be relatively limited as some or many of the parts within the box 400 may be preassembled (for example, operably connected to one or more other parts in the box 400 to assist with assembly or installation). The individual can accordingly, in certain embodiments, simply (i) assemble a few preassembled components of the mounting kit 300, as well as possibly some non-preassembled components of the mounting kit 300, (ii) install the partly, largely, or fully assembled components to the surface, and (iii) mount the one or more fabrications of the solar panel module 110 to the installed components. In one implementation, more than 40%, 45%, 50%, 55%, 60%, 65%, 70%, 75%, 80%, 85%, 90%, or 95% of the parts of a total number of the parts within the box 400 may be preassembled. Such preassembly can desirably, in certain embodiments, optimize the efficiency of assembly or installation of the parts of the box 400, increase quality in the assembly or installation process, make the assembly or installation process more error proof, or reduce the cost for assembly or installation of the parts within the box 400.

### Connector Cable

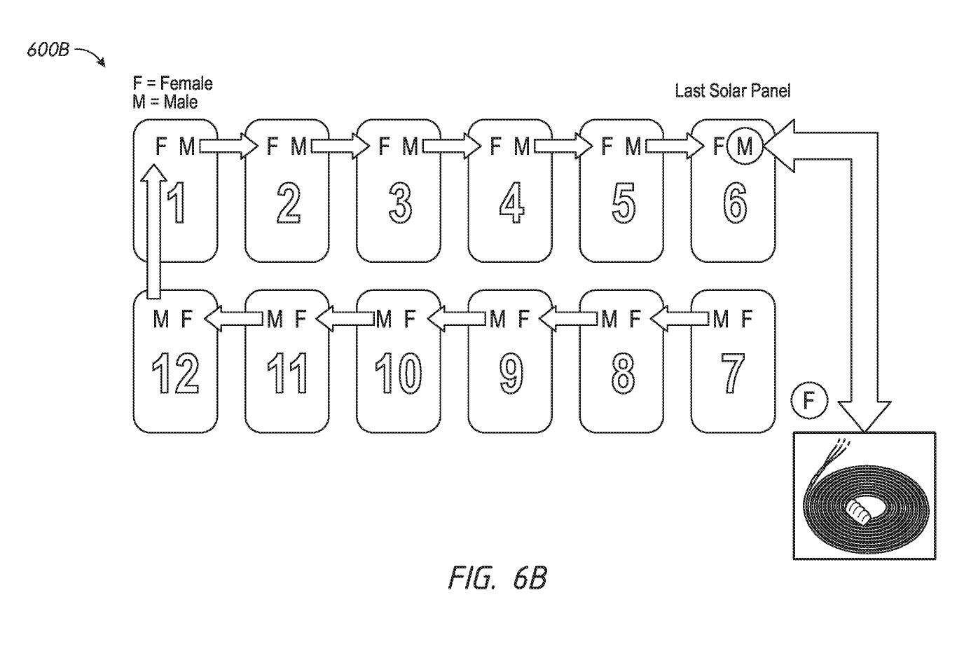

FIG. 5 illustrates a connector cable 500 for electrically connecting two solar panel modules like two fabrications of the solar panel module 110. The connector cable 500 can, for instance, be used to electrically connect the micro-inverter of one solar panel module to the micro-inverter of another solar panel module. The connector cable 500 can include a female plug 510 at one end of the connector cable 500 and a male plug 520 at an opposite end of the connector cable 500. The female plug 510 and the male plug 520 can be electrically connected via one or more conductor lines within a cover 530. Advantageously, in certain embodiments, the connector cable 500 can be used to electrically connect two solar panel modules without utilizing a separate conduit, such as a conduit, to cover the connector cable 500.

The male plug 520 can include a projection 522 usable to align, orient, and secure the male plug 520 with a receiving portion 512 of the female plug 510. The projection advantageously, in certain embodiments, can ensure that the properly matched conductors may be electrically connected and that the improperly matched conductors may not be electrically connected. In use, however, the male plug 520 would be operably connected to a female plug similar to the female plug 510, such as a female plug of the cable 226 or another solar panel module, to transfer electrical power, and the female plug 510 would be operably connected to a male plug similar to the male plug 520, such as a male plug of the cable 222 or another solar panel module, to transfer electrical power.

The connector cable 500 can be used to join two solar panel modules across a distance. The connector cable 500 can, for example, have a length that may be greater than the width of one, two, or three or more solar panels, such as a width of at least 50 cm, 90 cm, 100 cm, 150 cm, 180 cm, 250 cm, or 500 cm. The connector cable 500 can thus be used to electrically connect two solar panel modules at a distance greater than the width of one, two, or three or more solar panels, such as a distance enabling two solar panel modules atop two different structures, such as two different roofs, to be connected via the cable connector 500, for instance. In some implementations, the connector cable 500 can have a length of at least 10 feet, 20 feet, or 50 feet, for instance.

### Solar Panel Kit Configurations

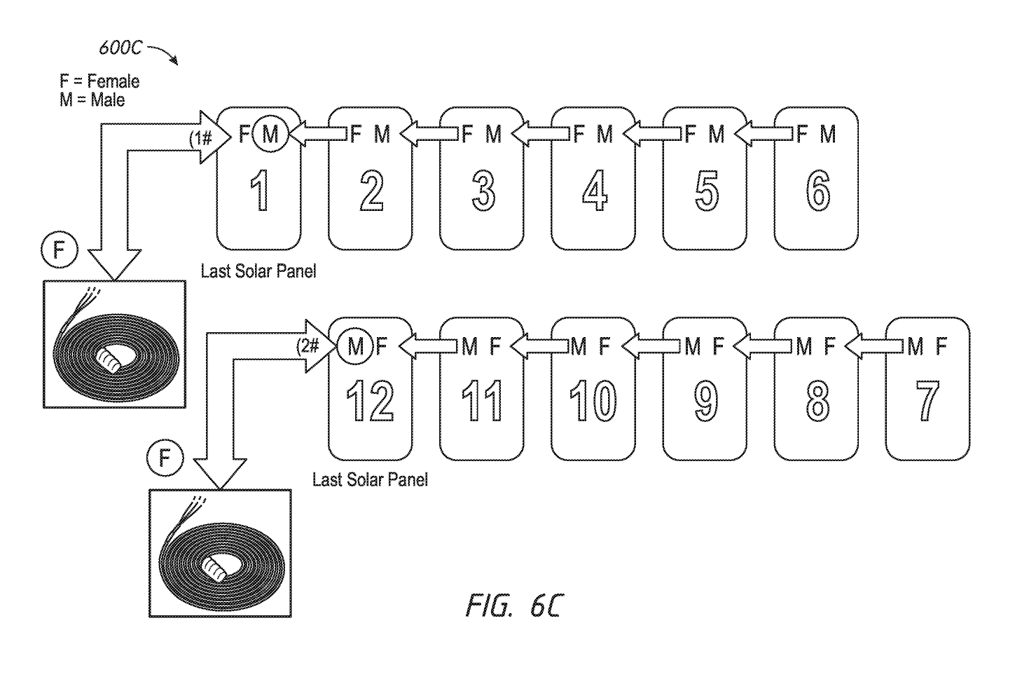

FIGS. 6A, 6B, 6C illustrate installation configurations 600A, 600B, 600C for one or more solar panel kits, such as one or more fabrications of the solar panel kit described with respect to FIG. 4. Each of the numbered rectangles in FIGS. 6A, 6B, and 6C can denote one solar panel module. The M and F references can respectively refer to male plug output connectors and female plug output connectors of the solar panel modules. Each solar panel module can, as shown, have one male plug output connector and one female plug output connector. The male and female plug output connectors can be usable to electrically connect the solar panel modules to one another in different configurations. FIGS. 6A and 6B illustration a series connection of twelves solar panel modules, and FIG. 6C illustrates to a first series connection of six solar panel modules and a second series connection of six solar panel modules.

### Terminology

Many other variations than those described herein will be apparent from this disclosure. For example, depending on the embodiment, certain acts, events, or functions of any of the algorithms described herein can be performed in a different sequence, can be added, merged, or left out all together (for example, not all described acts or events are necessary for the practice of the algorithm). Moreover, in certain embodiments, acts or events can be performed concurrently, for example. The term “connect,” can, in some instances, mean, imply, or indicate “couple.” The term “connected,” can, in some instances, mean, imply, or indicate “coupled.” The term “connecting,” can, in some instances, mean, imply, or indicate “coupling.” The term “couple,” can, in some instances, mean, imply, or indicate “connect.” The term “coupled,” can, in some instances, mean, imply, or indicate “connected.” The term “coupling,” can, in some instances, mean, imply, or indicate “connecting.”

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, for example, a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An example storage medium can be connected to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “for example,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A solar power generator kit comprising:
a plurality of solar panels comprising solar cells;
a plurality of micro-inverters mounted to the plurality of solar panels;
a plurality of photovoltaic junction boxes mounted to the plurality of solar panels;
a plurality of cables configured to electrically connect the plurality of solar panels to the plurality of micro-inverters and the plurality of photovoltaic junction boxes;
a plurality of mounting rails configured to mount the plurality of solar panels to a structure;
a plurality of coupling components configured to operably connect the plurality of mounting rails; and
a box storing the plurality of solar panels, the plurality of micro-inverters, the plurality of photovoltaic junction boxes, the plurality of cables, the plurality of mounting rails, and the plurality of coupling components.

2. The solar power generator kit of claim 1, wherein the solar cells are positioned on first sides of the plurality of solar panels, and the plurality of micro-inverters and the plurality of photovoltaic junction boxes are mounted on second sides of the plurality of solar panels opposite the first sides.

3. The solar power generator kit of claim 1, wherein the plurality of mounting rails and the plurality of coupling components are electrically grounded such that the plurality of mounting rails, the plurality of coupling components, and the plurality of solar panels share a common electrical ground when the plurality of mounting rails and the plurality of coupling components are operably connected and the plurality of solar panels are mounted to the plurality of mounting rails.

4. The solar power generator kit of claim 3, wherein the plurality of coupling components comprises a plurality of lugs, and when the plurality of mounting rails and the plurality of coupling components are operably connected and the plurality of solar panels are mounted to the plurality of mounting rails, the plurality of lugs is configured to align and secure the plurality of solar panels and conduct electrical current so that the plurality of solar panels share the common electrical ground.

5. The solar power generator kit of claim 1, wherein at least one of the plurality of cables comprises:
a plurality of conductor lines configured to electrically connect a first micro-inverter of the plurality of micro-inverters to a second micro-inverter of the plurality of micro-inverters to transfer power from the first micro-inverter to the second micro-inverter;
a female connector plug operably connected a first end of the plurality of conductor lines, the female connector plug configured to operably connect the plurality of conductor lines to the first micro-inverter; and
a male connector plug operably connected a second end of the plurality of conductor lines opposite the first end, the male connector plug configured to operably connect the plurality of conductor lines to the second micro-inverter.

6. The solar power generator kit of claim 1, wherein each of at least two of the plurality of cables comprises:
a plurality of conductor lines having a length greater than a width of a first solar panel of the plurality of solar panels, the plurality of conductor lines configured to electrically connect two of the plurality of micro-inverters;
a female connector plug operably connected a first end of the plurality of conductor lines, the female connector plug configured to operably connect the plurality of conductor lines to one of the two of the plurality of micro-inverters; and
a male connector plug operably connected a second end of the plurality of conductor lines opposite the first end, the male connected plug configured to operably connect the plurality of conductor lines to one of the two of the plurality of micro-inverters.

7. The solar power generator kit of claim 1, wherein one of the plurality of micro-inverters is mounted to each of the plurality of solar panels, and one of the plurality of photovoltaic junction boxes is mounted to each of the plurality of solar panels.

8. The solar power generator kit of claim 7, wherein a total number of solar panels of the plurality of solar panels is two, and each of the plurality of solar panels is configured to generate 250 W.

9. The solar power generator kit of claim 7, wherein a total number of solar panels of the plurality of solar panels is four.

10. A solar power generator device comprising:
a solar panel comprising solar cells on a first side of the solar panel, the solar cells configured to generate electricity from electromagnetic radiation incident on the solar cells; and
a micro-inverter mounted on a second side of the solar panel opposite the first side.

11. The solar power generator device of claim 10, wherein the micro-inverter is mounted to a frame along a perimeter of the solar panel.

12. The solar power generator device of claim 11, wherein the frame comprises a flange, and the micro-inverter is mounted to the flange.

13. The solar power generator device of claim 12, wherein the micro-inverter is mounted with a fastener to the flange.

14. The solar power generator device of claim 12, wherein the micro-inverter is mounted within an open portion of the solar panel on the second side so that the micro-inverter does not project from the open portion beyond a plane extending level with an outer periphery surface of the flange.

15. The solar power generator device of claim 10, wherein the micro-inverter is mounted so that the micro-inverter does not project beyond a back outer periphery surface or an edge outer periphery surface of the solar panel.

16. The solar power generator device of claim 15, further comprising a photovoltaic junction box mounted to the solar panel within the open portion so that the photovoltaic junction box does not project beyond the top edge and the back edge.

17. An assembly comprising:
a first solar panel comprising solar cells, the solar cells configured to generate electricity from electromagnetic radiation incident on the solar cells; and
a first cable comprising:
a plurality of conductor lines having a length greater than a width of the first solar panel, the plurality of conductor lines configured to electrically connect a first micro-inverter associated with the first solar panel to a second micro-inverter,
a female connector plug operably connected a first end of the plurality of conductor lines, the female connector plug configured to operably connect to the first micro-inverter, and
a male connector plug operably connected a second end of the plurality of conductor lines opposite the first end, the male connector plug configured to operably connect to the second micro-inverter.

18. The assembly of claim 17, in combination with the first micro-inverter and the second micro-inverter, and further comprising a second solar panel, the second micro-inverter associated with the second solar panel, the plurality of conductor lines has a length greater than a combined width of the first solar panel and the second solar panel.

19. The assembly of claim 17, further comprising a second solar panel associated with the second micro-inverter, and wherein the first solar panel and the second solar panel are mounted on a structure and separated by a distance of at least the width of the first solar panel, the width of the first solar panel being 99.2 cm, and the first micro-inverter and the second micro-inverter are electrically connected via the plurality of conductor lines.

20. The assembly of claim 19, wherein the first solar panel and the second solar panel are separated by a distance of at least a combined width of the first solar panel and the second solar panel.

21. The assembly of claim 17, further comprising:
a second solar panel associated with the second micro-inverter; and
a second cable configured to operably connect the second micro-inverter to a third micro-inverter, the second cable having a length less than the width of the first solar panel.

22. The assembly of claim 17, wherein the female connector plug is capable of operably connecting to the male connector plug.
